(19) United States
(12) Patent Application Publication
(10) Pub. No.: US 2008/0056670 A1
(43) Pub. Date: Mar. 6, 2008

(54) RECORDING/REPRODUCING APPARATUS

(75) Inventor: Mutsuyuki OKAYAMA, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/845,925

(22) Filed: Aug. 28, 2007

(30) Foreign Application Priority Data
Aug. 29, 2006 (JP) 2006-231747

(51) Int. Cl. H04N 5/91; H04N 7/087

(52) U.S. Cl. 386/84; 386/85; 386/E05.001

(57) ABSTRACT

There is provided an inexpensive recording/reproducing apparatus that enables a user, without using a conventional video signal switching device, to view and listen to distortion-free video and audio in various applications, such as recording or reproducing of digital or analog broadcasts, broadcast viewing, etc. The apparatus includes a digital TV signal processor and a recording processor, and implements an output processing on the digital TV signal processor side, with no need to have two final output units. In addition, the apparatus includes, in a system for generating reference clocks of the digital TV signal processor and the recording processor, a switch(es) for selectively transferring the optimum reference clock to each of the processors and optionally a PLL(s) for removing an unstable component that arises during transition of switching by the switch(es). The switch(es) is controlled properly to suit the application.

### BACKGROUND OF THE INVENTION

(1) Field of the Invention

The present invention relates to a recording/reproducing apparatus, and more particularly to a recording/reproducing apparatus that records and reproduces both of digital broadcasts and analog broadcasts.

(2) Description of the Related Art

At the time of recording, a conventional apparatus for recording and reproducing digital broadcasts extracts a program clock reference (hereinafter, referred to as a “PCR”) from an input stream and performs recording processing using a clock that is synchronized with the PCR as a reference clock. At the time of reproducing, this type of apparatus performs reproducing processing using a more accurate fixed clock as the reference clock (see, for example, Japanese Patent Application Publication No. 2006-134390).

Meanwhile, another type of conventional apparatus for recording digital broadcasts and analog broadcasts includes a digital TV signal processor, a recording/reproducing processor, and a video signal switching device. The digital TV signal processor receives a digital broadcast stream and outputs video and audio. The recording/reproducing processor records and reproduces the analog broadcasts. The video signal switching device selects either video signals outputted from the digital TV signal processor or video signals outputted from the recording/reproducing processor, and thereby outputs the selected signals to be viewed and listened to. Note that the expression “outputting to be viewed and listened to” means reproducing.

There has been still another conventional recording/reproducing apparatus which is a combination of the above two types of conventional apparatuses, and is able to record and reproduce both of digital broadcasts and analog broadcasts. In this conventional recording/reproducing apparatus, the video signal switching device is necessary to switch the reference clock to another clock, depending on whether recording or reproducing is performed. Without the video signal switching device, this conventional recording/reproducing apparatus fails to provide distortion-free video and audio to be viewed and listened to.

The conventional video signal switching device, however, needs high production cost and eventually results in high price, so that it has been quite difficult to reduce the price of the conventional recording/reproducing apparatus to an affordable price range.

### SUMMARY OF THE INVENTION

In order to address the above problem, an object of the present invention is to provide a recording/reproducing apparatus which can provide, in various situations, distortion-free video and audio to be viewed and listened to, without using the expensive video signal switching device, which makes it possible to reduce a cost and eventually a price of the recording/reproducing apparatus. Examples of the various situations are recording and reproducing of digital broadcasts and analog broadcasts, viewing of the broadcasts, and the like.

The recording/reproducing apparatus according to the present invention receives, records, and reproduces a digital broadcast and an analog broadcast. The recording/reproducing apparatus includes: a digital television signal processor operable to (i) receive the digital broadcast, (ii) extract a program clock reference signal from a stream of the received digital broadcast, (iii) output a digital signal of the digital broadcast, according to a first reference clock signal which is generated based on the program clock reference signal, and (iv) output a digital signal of the analog broadcast of a recording processor; the recording processor operable to (i) receive the analog broadcast, (ii) extract a vertical synchronization signal from the received analog broadcast, (iii) digitalize the received analog broadcast, and (iii-1) record the digital signal of the analog broadcast into which the analog broadcast is digitalized onto a recording medium or (iii-2) output the digital signal of the analog broadcast to the digital television signal processor, according to a second reference clock signal which is generated based on the vertical synchronization signal, and (iv) simultaneously or independently record, onto the recording medium, the digital signal of the digital broadcast which is received from the digital television signal processor; and a provision unit operable to (i) provide, as a clock signal, one of (a″) the first reference clock signal and (b″) the second reference clock signal to the digital television signal processor, and (ii) provide, as a clock signal, one of (a″) the first reference clock signal and (b″) the second reference clock signal to the recording processor, wherein the digital television signal processor is operable to output the digital signal of the analog broadcast according to the second reference clock signal instead of the first reference clock signal, when the second reference clock signal is provided as the clock signal from the provision unit, and the recording processor is operable to record the digital signal of the digital broadcast onto the recording medium, according to the first reference clock signal instead of the second reference clock signal, when the first reference clock signal is provided as the clock signal from the provision unit.

Further, the provision unit may be operable to provide the first reference clock signal as the clock signal to the recording processor, when the recording processor records the digital signal of the digital broadcast onto the recording medium. The provision unit may also be provide the second reference clock signal as the clock signal to the digital television signal processor, when the digital television signal processor outputs the digital signal of the analog broadcast, in order to be viewed or listened to, the digital signal being received from the recording processor.

Furthermore, the provision unit may include: a first clock signal generation unit operable to generate the first reference clock signal based on the program clock reference signal; a second clock signal generation unit operable to generate the second reference clock signal based on the vertical synchronization signal; and a selection unit operable to (i) select one of the first reference clock signal and the second reference clock signal, and (ii) provide the selected reference clock signal as the clock signal.

Still further, the first clock signal generation unit may include: a first low pass filter operable to smooth (a) a phase difference signal between the first reference clock signal and the program clock reference signal; and a first voltage controlled oscillator operable to output (a″) the first reference clock signal which has a frequency depending on the phase difference signal smoothed by the first low pass filter, and the second clock signal generation unit includes: a second low pass filter operable to smooth (b) a phase difference signal between the second reference clock signal and the vertical synchronization signal; and a second voltage controlled oscillator operable to output (b″) the second reference clock signal which has a frequency depending on the phase difference signal smoothed by the second low pass filter. The provision unit may further include a phase synchronization circuit operable to remove an unstable phase component from the first reference clock signal or the second reference clock signal which is outputted by the selection unit.

Still further, the recording and reproducing apparatus may further include: an audio signal conversion unit operable to convert an analog audio signal of the analog broadcast into a digital audio signal; a clock output unit operable to output the clock signal provided by the provision unit to the audio signal conversion unit; and an audio output unit operable to (i) select one of (m) the digital audio signal which is obtained from the audio signal conversion unit and (n) a digital audio signal of the digital signal of the analog broadcast and the digital broadcast, which is obtained from the recording processor, and (ii) outputs the selected digital audio signal to the digital television signal processor.

Still further, the provision unit may include a clock signal generation unit operable to generate the first reference clock signal based on the program clock reference signal or the second reference clock signal based on the vertical synchronization signal, wherein the clock signal generation unit includes: a first low pass filter operable to smooth (a) a phase difference signal between the first reference clock signal and the program clock reference signal; a second low pass filter operable to smooth (b) a phase difference signal between the second reference clock signal and the vertical synchronization signal; a switch operable to select one of (a′) a first signal which is smoothed and outputted by the first low pass filter and (b′) a second signal which is smoothed and outputted by the second low pass filter; and a voltage controlled oscillator operable to output (a″) the first reference clock signal which has a frequency depending on the first signal or (b″) the second reference clock signal which has a frequency depending on the second signal, the first and second signal being selected by the switch.

Still further, the provision unit may include a clock signal generation unit operable to generate the first reference clock signal based on the program clock reference signal or the second reference clock signal based on the vertical synchronization signal, wherein the clock signal generation unit includes: a first low pass filter operable to smooth (a) a phase difference signal between the first reference clock signal and the program clock reference signal; a second low pass filter operable to smooth (b) a phase difference signal between the second reference clock signal and the vertical synchronization signal; a switch operable to select one of (a′) a first signal which is smoothed and outputted by the first low pass filter and (b′) a second signal which is smoothed and outputted by the second low pass filter; and a voltage controlled oscillator operable to output (a″) the first reference clock signal which has a frequency depending on the first signal or (b″) the second reference clock signal which has a frequency depending on the second signal, the first and second signal being selected by the switch.

Still further, the provision unit may include a clock signal generation unit operable to generate (a″) the first reference clock signal based on the program clock reference signal or (b″) the second reference clock signal based on the vertical synchronization signal, wherein the clock signal generation unit includes: a switch operable to select one of (a) a phase difference signal between the first reference clock signal and the program clock reference signal which is extracted by the digital television signal processor and (b) a phase difference signal between the second reference clock signal and the vertical synchronization signal which is extracted by the recording processor; a low pass filter operable to smooth (a) the phase difference signal between the first reference clock signal and the program clock reference signal or (b) the phase difference signal between the second reference clock signal and the vertical synchronization signal, the phase difference signal to be smoothed being selected by the switch; and a voltage controlled oscillator operable to output (a″) the first reference clock signal which has a frequency depending on the phase difference signal between the first reference clock signal and the program clock reference signal or (b″) the second reference clock signal which has a frequency depending on the phase difference signal between the second reference clock signal and the vertical synchronization signal, the phase difference signal being smoothed by the low pass filter.

Still further, the provision unit may include a clock signal generation unit operable to generate (a″) the first reference clock signal based on the program clock reference signal or (b″) the second reference clock signal based on the vertical synchronization signal, wherein the clock signal generation unit includes: a first low pass filter operable to smooth (a) a phase difference signal between the first reference clock signal and the program clock reference signal; a second low pass filter operable to smooth (b) a phase difference signal between the second reference clock signal and the vertical synchronization signal; a first switch and a second switch, each of which is operable to select one of (a′) a first signal which is smoothed by the first low pass filter and (b′) a second signal which is smoothed by the second low pass filter; a first voltage controlled oscillator operable to output (a″) the first reference clock signal which has a frequency depending on the first signal or (b″) the second reference clock signal which has a frequency depending on the second signal, the first and second signal being selected by the first switch; a second voltage controlled oscillator operable to output (a″) the first reference clock signal which has a frequency depending on the first signal or (b″) the second reference clock signal which has a frequency depending on the second signal, the first and second signal being selected by the second switch; and wherein the provision unit is operable to provide, as the clock signal, the first or second reference clock signal outputted from the first voltage controlled oscillator, to the digital television signal processor, and provide, as the clock signal, the first or second reference clock signal outputted from the second voltage controlled oscillator, to the recording processor.

Still further, the provision unit may include: a selection unit operable to select one of (a) a phase difference signal between the first reference clock signal and the program clock reference signal and (b) a phase difference signal between the second reference clock signal and the vertical synchronization signal; and a clock signal generation unit operable to generate (a″) the first reference clock signal based on the phase difference signal between the first reference clock signal and the program clock reference signal, or (b″) the second reference clock signal based on the phase difference signal between the second reference clock signal and the vertical synchronization signal, the phase difference signal being selected by the selection unit, wherein the clock signal generation unit includes: a low pass filter operable to smooth (a) the phase difference signal between the first reference clock signal and the program clock reference signal or (b) the phase difference signal between the second reference clock signal and the vertical synchronization signal, the phase difference signal to be smoothed being selected by the selection unit; a first voltage controlled oscillator and a second voltage controlled oscillator, each of which is operable to output (a″) the first reference clock signal which has a frequency depending on the phase difference signal between the first reference clock signal and the program clock reference signal, or (b″) the second reference clock signal which has a frequency depending on the phase difference signal between the second reference clock signal and the vertical synchronization signal, the phase difference signal being smoothed by the low pass filter, wherein the provision unit is operable to provide, as the clock signal, the first or second reference clock signal outputted from the first voltage controlled oscillator, to the digital television signal processor, and provide, as the clock signal, the first or second reference clock signal outputted from the second voltage controlled oscillator, to the recording processor.

Moreover, the recording and reproducing apparatus according to the present invention includes: a digital television signal processor operable to (i) receive the digital broadcast, (ii) extract a program clock reference signal from a stream of the received digital broadcast, (iii) output a digital signal of the digital broadcast, according to a first reference clock signal which is generated based on the program clock reference signal, and (iv) output a digital signal of the analog broadcast which is outputted from a recording processor; the recording processor operable to (i) receive the analog broadcast, (ii) extract a vertical synchronization signal from the received analog broadcast, (iii) digitalize the received analog broadcast, and (iii-1) record the digital signal of the analog broadcast into which the analog broadcast is digitalized onto a recording medium or (iii-2) output the digital signal of the analog broadcast to the digital television signal processor, according to a second reference clock signal which is generated based on the vertical synchronization signal, and (iv) simultaneously or independently record, onto the recording medium, the signals of the digital broadcast which is received from the digital television signal processor; a circuit includes (x) a rate conversion circuit operable to convert a digital baseband signal into a standard signal in synchronization with the first reference clock signal, the digital baseband signal being a video signal of the digital signal of the analog broadcast which is digitalized and outputted from the recording processor, and (y) a phase difference signal detection circuit operable to detect a phase difference signal by comparing the digital baseband signal with the first reference clock signal and output the detected phase difference signal; a switch operable to select one of (a) a phase difference signal between the first reference clock signal and the program clock reference signal which is extracted by the digital television signal processor, and (c) the phase difference signal which is outputted from the circuit; a first low pass filter operable to smooth (a) the phase difference signal between the first reference clock signal and the program clock reference signal, or (c) the phase difference signal which is outputted from the circuit, the phase difference signal to be smoothed being selected by the switch; a first voltage controlled oscillator operable to output (a″) the first reference clock signal which has a frequency depending on the phase difference signal smoothed by the first low pass filter; a second low pass filter operable to smooth (b) a phase difference signal between the first reference clock signal and the vertical synchronization signal which is extracted by the recording processor; and a second voltage controlled oscillator operable to output (b″) the second reference clock signal which has a frequency depending on the phase difference signal smoothed by the second low pass filter.

According to the recording/reproducing apparatus of the present invention, it is possible to provide, in various situations, distortion-free video and audio to be viewed and listened to, without using the expensive video signal switching device, which makes it possible to reduce a cost and eventually a price of the recording/reproducing apparatus. Examples of the various situations are recording and outputting of digital broadcasts and analog broadcasts, reproducing the broadcasts, and the like.

### FURTHER INFORMATION ABOUT TECHNICAL BACKGROUND TO THIS APPLICATION

The disclosure of Japanese Patent Application No. 2006-231747 filed on Aug. 29, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate specific embodiments of the present invention. In the Drawings:

FIG. 1 is a block diagram illustrating a structure of a recording/reproducing apparatus according to the first embodiment of the present invention;

FIG. 2 is a block diagram illustrating a structure of a recording/reproducing apparatus according to the second embodiment of the present invention;

FIG. 3 is a block diagram illustrating a structure of a recording/reproducing apparatus according to the third embodiment of the present invention;

FIG. 4 is a block diagram illustrating a structure of a recording/reproducing apparatus according to the fourth embodiment of the present invention;

FIG. 5 is a block diagram illustrating a structure of a recording/reproducing apparatus according to the fifth embodiment of the present invention; and

FIG. 6 is a block diagram illustrating a structure of a recording/reproducing apparatus according to the sixth embodiment of the present invention.

### DESCRIPTION OF THE PREFERRED EMBODIMENTS

### First Embodiment

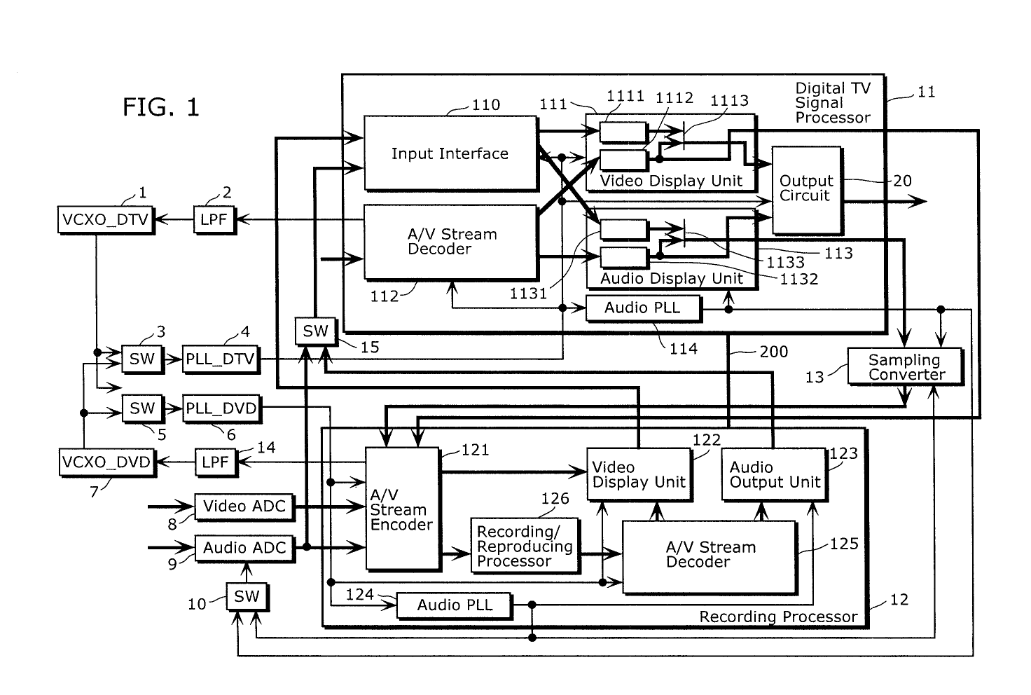

Referring to FIG. 1, a recording/reproducing apparatus according to the first embodiment of the present invention will now be described below.

FIG. 1 is a block diagram illustrating the recording/reproducing apparatus according to the first embodiment of the present invention.

The recording/reproducing apparatus according to the first embodiment receives, records, and reproduces both of digital broadcasts and analog broadcasts. As shown in FIG. 1, the recording/reproducing apparatus includes a digital TV signal processor 11, and a recording processor 12, a first voltage controlled oscillator 1, a first low pass filter 2, a first switch 3, a first Phase-Locked Loop (PLL) 4, a second switch 5, a second PLL 6, a second voltage controlled oscillator 7, a video AD converter (ADC) 8, an audio AD converter (ADC) 9, an audio clock switch 10, a sampling converter 13, a second low pass filter 14, an audio signal switch 15, and a communication unit 200.

The digital TV signal processor 11 includes an HDMI/video audio output circuit (hereinafter, referred to as an “output circuit”) 20, an A/V baseband digital signal input interface (hereinafter referred to also as an “input interface”) 110, a video display unit 111, an A/V stream decoder 112, an audio output unit 113, and an audio PLL 114. Here, the video display unit 111 includes an input buffer 1111, an input buffer 1112, and a switch 1113. The audio display unit 113 includes an input buffer 1132 and a switch 1133.

The recording processor 12 includes an A/V stream encoder 121, a video display unit 122, an audio output unit 123, an audio PLL 124, an A/V stream decoder 125, and a recording/reproducing processor 126.

The first voltage controlled oscillator 1 corresponds to the first voltage controlled oscillator which is claimed in the present invention. The first voltage controlled oscillator 1 outputs a first reference clock signal having a frequency depending on a signal smoothed by the first low pass filter 2. More specifically, the first voltage controlled oscillator 1 generates a reference clock from a signal inputted from the first low pass filter 2, and provides the reference clock to the first switch 3 and the second switch 5.

The first low pass filter 2 (shown as LPF in the figures) corresponds to the first low pass filter which is claimed in the present invention. The first low pass filter 2 smoothes a phase difference signal between the first reference clock signal and the PCR signal. More specifically, the first low pass filter 2 smoothes an input phase difference signal which has been generated by the A/V stream decoder 112 in the digital TV signal processor 11, and provides the smoothed signal to the first voltage controlled oscillator 1.

The first switch 3 corresponds to a selection unit which is claimed in the present invention. The first switch 3 selects the first reference clock signal or the second reference clock signal which will be explained further below. Then, the first switch 3 outputs the selected reference clock signal. More specifically, the first switch 3 selects a reference cloak signal outputted from the first voltage controlled oscillator 1 or a reference clock signal outputted from the second voltage controlled oscillator 7, and provides the selected reference clock signal to the first PLL 4.

The first PLL 4 (shown as PLL_DTV in the figures) corresponds to a phase synchronization circuit which is claimed in the present invention. The first PLL 4 removes unstable phase components from the first reference clock signal or the second reference clock signal outputted by the first switch 3. More specifically, to the digital TV processor 11, the first PLL 4 provides a reference clock signal which is obtained by removing unstable phase components from the reference clock signal of the first switch 3. The unstable phase components are generated during transition of switching by the first switch 3.

The second switch 5 (shown as SW in the figures) corresponds to a selection unit which is claimed in the present invention. The second switch 5 selects the first reference clock signal or the second reference clock signal, and outputs the selected reference clock signal. More specifically, the second switch 5 selects the first reference clock signal outputted from the first voltage controlled oscillator 1 or the reference clock signal outputted from the second voltage controlled oscillator 7, and outputs the selected reference clock signal to the second PLL 6.

The second PLL 6 (shown as PLL_DVD in the figures) provides, to the recording processor 12, a reference clock signal which is obtained by removing unstable phase components from the reference clock signal of the second switch 5. The unstable phase components are generated during transition of switching by the second switch 5.

The second voltage controlled oscillator 7 (shown as PLL_DVD in the figures) corresponds to a second voltage controlled oscillator which is claimed in the present invention. The second voltage controlled oscillator 7 outputs the second reference clock signal having a frequency depending on a signal smoothed by the second low pass filter 14. More specifically, the second voltage controlled oscillator 7 generates a reference clock signal from a signal inputted from the second low pass filter 14, and provides the generated reference clock signal to the first switch 3 and the second switch 5.

The video AD converter 8 (shown as video ADC in the figures) receives analog video signals, then converts the received analog video signals into digital video signals, and outputs the digital video signals to the A/V stream encoder 121 as digital baseband signals.

The audio AD converter 9 (shown as audio ADC in the figures) corresponds to an audio signal conversion unit which is claimed in the present invention. The audio AD converter 9 converts analog audio signals which are received from an analog broadcast, into digital audio signals. More specifically, when an analog broadcast is received, the audio AD converter 9 converts input analog audio signals of the analog broadcast into digital audio signals, and outputs the digital audio signals to the A/V stream encoder 121 as digital baseband signals.

The audio clock switch 10 (shown as SW in the figures) selects the clock signal outputted from the audio PLL 114 in the digital TV signal processor 11 or a clock signal outputted from the audio PLL 124 in the recording processor 12, and then outputs the selected clock signal to the audio AD converter 9.

The digital TV signal processor 11 corresponds to a digital television signal processor which is claimed in the present invention. The digital TV signal processor 11 receives a digital broadcast, then extracts a PCR signal in a stream of the received digital broadcast. Then, the digital TV signal processor 11 (i) outputs video and audio digital signals of the received digital broadcast in order to be viewed and listened to, according to the first reference clock signal which is generated based on the PCR signal, or (ii) outputs the video and audio digital signals to the recording processor 12 according to the first reference clock signal. In other words, the digital TV signal processor 11 receives a digital broadcast stream, and (i) outputs video and audio signals of the digital broadcast stream, in order to be viewed and listened to, or (ii) outputs the video and audio signals of the digital broadcast to the digital TV signal processor 11. In addition, the digital TV signal processor 11 extracts a PCR signal from the received digital broadcast stream.

The recording processor 12 corresponds to a recording processor which is claimed in the present invention. The recording processor 12 receives an analog broadcast, then extracts a vertical synchronization signal of the received analog broadcast, then digitalizes and (i) records, onto a recording medium, the received analog broadcast according to the second reference clock signal which is generated based on the vertical synchronization signal, or (ii) output the received and digitalized analog broadcast to the digital TV signal processor 11 according to the second reference clock signal. In addition, the recording processor 12 simultaneously or independently records the digital signals of the digital broadcast outputted from the digital TV signal processor 11 onto a recording medium. More specifically, the recording processor 12 receives an analog broadcast and records the analog broadcast onto the recording medium. In addition, the recording processor 12 extracts a vertical synchronization signal from the analog broadcast. Moreover, the recording processor 12 records a stream of a digital broadcast onto a recording medium via the recording/reproducing processor 126. In other words, the recording processor 12 (i) records an analog broadcast onto a recording medium or (ii) output the analog broadcast to the digital TV signal processor 11. In addition, the recording processor 12 simultaneously or independently records a digital broadcast onto a recording medium.

The sampling converter 13 converts a sampling frequency of the audio signals received from the digital TV signal processor 11, and then provides the converted frequency to the A/V stream encoder 121 in the recording processor 12.

The second low pass filter 14 (shown as LPF in the figures) corresponds to the second low pass filter which is claimed in the present invention. The second low pass filter 14 smoothes the phase difference signals between the second reference clock signal and the vertical synchronization signals. More specifically, the second low pass filter 14 smoothes the phase difference signals which are generated and provided by the A/V stream encoder 121 in the recording processor 12, and provides the smoothed phase difference signal to the second voltage controlled oscillator 7.

The audio signal switch 15 corresponds to an audio output unit which is claimed in the present invention. The audio signal switch 15 selects a digital audio signal outputted from the audio ADC 9 or a digital audio signal outputted from the recording processor 12, and then provides the selected digital audio signal to the digital TV signal processor 11. More specifically, the audio signal switch 15 selects (i) a signal from the audio ADC 9 or (ii) a signal from the audio output unit 123 which is a function in the recording processor 12, and then provides the selected signal to the input interface 110 which is a function of the digital TV signal processing unit 11.

The output circuit 20 outputs video signals from the video display unit 111 and audio signals from the audio output unit 113 to an external apparatus such as a reproducing apparatus, in order to be viewed and listened to.

The input interface 110, which is a function in the TV signal processor 11, receives a baseband video signal from the video display unit 122 and a baseband audio signal from the audio signal switch 15, and outputs the baseband video signal and the baseband audio signal to the video display unit 111 and the audio output unit 113, respectively.

The video display unit 111, which is another function in the TV signal processor 11, provides, to the output circuit 20, (i) the baseband video signals inputted from the A/V stream decoder 112 or (ii) the video signals inputted from the input interface 110. The video display unit 111 provides the baseband video signals inputted is from the A/V stream decoder 112, also to the A/V stream encoder 121.

The A/V stream decoder 112, which is still another function in the TV signal processor 11, decodes a format unique to a received digital broadcast, regarding contents of the digital broadcast. The A/V stream decoder 112 provides the decoded baseband video signals to the video display unit 111, and provides the decoded baseband audio signals to the audio output unit 113. In addition, the A/V stream decoder 112 generates a phase difference signal, by comparing a reference clock signal to a PCR which is extracted from a content of received digital broadcast. The A/V stream decoder 112 provides the generated phase difference signal to the first low pass filter 2.

The audio output unit 113, which is a function in the TV signal processor 11, selects (i) a baseband audio signal inputted from the A/V stream decoder 112 or (ii) a baseband audio signal inputted from the input interface 110, and then outputs the selected baseband audio signal to the sampling converter 13. In addition, to the output circuit 20, the audio output unit 113 provides the baseband audio signal inputted from the A/V stream decoder 112.

The audio PLL 114, which is still another function in the TV signal processor 11, provides the reference clock signal provided from the first PLL 4, to the audio output unit 113, the sampling converter 13, and the audio clock switch 10.

The A/V stream encoder 121, which is a function in the recording processor 12, converts the digital baseband video signals inputted from the video ADC 8, into a stream of MPEG-2, a DVD format, or the like, and then outputs the converted data to the recording/reproducing processor 126 and the video display unit 122.

The video display unit 122, which is another function in the recording processor 12, transmits a digital baseband signal inputted from the A/V stream encoder 121 or the A/V stream decoder 125, to the input interface 110 which is a function of the digital TV signal processor 11.

The audio output unit 123, which is still another function in the recording processor 12, outputs the decoded baseband audio signal inputted from the A/V stream decoder 125, to the audio signal switch 15.

The audio PLL 124, which is still another function in the recording processor 12, outputs the reference clock signal provided from the second PLL 6, to the audio output unit 123, the sampling converter 13, and the audio clock switch 10.

The A/V stream decoder 125, which is still another function in the recording processor 12, decodes a content or a stream which has been recorded on a recording medium and is provided from the recording/reproducing processor 126 to the A/V stream decoder 125.

The A/V stream decoder 125, which is still another function in the recording processor 12, provides the decoded baseband video signal to the video display unit 122, and provides the decoded baseband audio signal to the audio output unit 123.

The recording/reproducing processor 126, which is still another function in the recording processor 12, processes the stream inputted from the A/V stream encoder 121 in order to be recorded, and then records the processed stream onto a recording medium. Alternatively, the recording/reproducing processor 126 outputs the processed stream to the digital TV signal processor 11.

The communication unit 200 performs communication between a CPU of the digital TV signal processor 11 and a CPU of the recording processor 12.

The input buffer 1111 temporarily holds baseband video signals inputted from the input interface 110.

The input buffer 1112 temporarily holds baseband video signals inputted from the A/V stream decoder 112.

The switch 1113 selects the baseband video signal from the input buffer 1111 or the baseband video signal from the input buffer 1112.

The input buffer 1131 temporarily holds baseband audio signals inputted from the input interface 110.

The input buffer 1132 temporarily holds baseband audio signals inputted from the A/V stream decoder 112.

The switch 1133 selects a baseband audio signal from the input buffer 1131 or the baseband video signal from the input buffer 1132.

In order to facilitate the explanation, the flow of the signals and generation of the reference clocks will now be described below in the following four cases: 1) the case where an analog broadcast is outputted to be viewed and listened to; 2) the case where video recorded on a DVD is reproduced to be viewed and listened to; 3) the case where while the digital broadcast is recorded onto a DVD, a content recorded on the DVD is reproduced to be viewed and listened to; and 4) the case where while the digital broadcast is outputted to be viewed and listened to, the analog broadcast is recorded.

First, the case where an analog broadcast is outputted to be viewed and listened to will now be described below.

When the recording/reproducing apparatus receives an analog broadcast, a video signal of the analog broadcast is inputted to the video ADC 8, then converted therein into a digital baseband video signal, and then outputted to the A/V stream encoder 121. The A/V stream encoder 121 converts the digital baseband video signal into a MPEG2 stream or a DVD format, for example, and, at the same time, detects a phase difference between the vertical synchronization signal and the reference clock supplied from the second PLL 6 to output the phase difference signal to the second low pass filter 14. The second low pass filter 14 receives and smoothes the phase difference signal, and outputs a control voltage to the second voltage controlled oscillator 7. The second voltage controlled oscillator 7 receives the control voltage and generates the reference clock in accordance with the received control voltage, and outputs the generated reference clock to the first switch 3 and the second switch 5. Of the reference clock outputted from the first voltage controlled oscillator 1 and the reference clock outputted from the second voltage controlled oscillator 7, the second switch 5 selected the reference clock outputted from the second voltage controlled oscillator 7 and outputs the selected reference clock to the second PLL 6. The second PLL 6 receives the reference clock and removes therefrom the unstable phase component that arises during the transition of switching by the second switch 5, and supplies the resulting reference clock to the recording processor 12.

Meanwhile, the digital baseband video signal inputted to the A/V stream encoder 121 is outputted to the video display unit 122. The video display unit 122 receives the digital baseband video signal and outputs the received digital baseband video signal to the input interface 110, which forms a part of the digital TV signal processor 11. Next, the flow of the audio signal will now be described below. The analog audio signal inputted to the audio ADC 9 is converted therein into the digital audio signal, and the digital audio signal is outputted to the audio signal switch 15 and the A/V stream encoder 121, which forms a part of the recording processor 12. As described above, the audio signal switch 15 has a function of selecting either the signal outputted from the audio ADC 9 or the signal outputted from the audio output unit 123, which forms a part lo of the recording processor 12. In the case where the analog broadcast is outputted to be viewed and listened to, the audio signal switch 15 selects the signal outputted from the audio ADC 9, and outputs the selected signal to the input interface 110, which forms a part of the digital TV signal processor 11.

Here, a clock inputted to the digital TV signal processor 11 will now be described below. Because the digital TV signal processor 11 receives the video signal from the recording processor 12 and outputs the received video signal via the video display unit 111 and the output circuit 20, the reference clock of the digital TV signal processor 11 need be identical with that of the recording processor 12. Accordingly, the first switch 3 selects the clock outputted from the second voltage controlled oscillator 7 and outputs the selected clock to the first PLL 4. The first PLL 4 receives the clock and removes therefrom the unstable phase component of the received clock that arises during the transition of switching by the first switch 3, and supplies the resulting reference clock to the digital TV signal processor 11. As a result, the reference clock of the digital TV signal processor 11 becomes identical with the reference clock of the recording processor 12. The reference clock supplied to the digital TV signal processor 11 is distributed to the input interface 110, the video display unit 111, the output circuit 20, the audio PLL 114, and the A/V stream decoder 112. The internal parts of the digital TV signal processor 11 thus operate in synchronism with the reference clock of the recording processor 12, resulting in an ability to output the video signal free of distortion. The audio clock switch 10 for selecting a clock to be supplied to the audio ADC 9 selects either the clock generated by the audio PLL 114 within the digital TV signal processor 11 or the clock generated by the audio PLL 124 within the recording processor 12. Because the audio clock switch 10 may select either of the clocks in this case, it is assumed here that the audio clock switch 10 selects the clock generated by the audio PLL 114 within the digital TV signal processor 11, for example.

Note that the encoded stream outputted from the A/V stream encoder 121 within the recording processor 12 is outputted to the recording/reproducing processor 126. The encoded stream may be subjected to proper processing in the recording/reproducing processor 126, and thereafter recorded on the recording medium.

Next, the case where the video recorded on a DVD is reproduced to be viewed and listened to will now be described below.

Data of content recorded on the recording medium is subjected to proper reproducing processing in the recording/reproducing processor 126 within the recording processor 12, and the resulting data is outputted to the A/V stream decoder 125 in the form of a data stream. The A/V stream decoder 125 receives and decodes the data stream, and outputs a resulting baseband video signal and baseband audio signal to the video display unit 122 and the audio output unit 123, respectively. The video display unit 122 receives the baseband video signal, and outputs the received baseband video signal to the input interface 110. The switch 15 selects the baseband audio signal outputted from the audio output unit 123, and outputs the selected baseband audio signal to the input interface 110.

Here, the reference clock of the digital TV signal processor 11 will now be described below.

In this case, the digital TV signal processor 11 receives both the video and audio signals from the recording processor 12 to output the video and the audio. Accordingly, the reference clock of the digital TV signal processor 11 need be identical with that of the recording processor 12. Accordingly, of the clock outputted from the first voltage controlled oscillator 1 and the clock outputted from the second voltage controlled oscillator 7, the first switch 3 and the second switch 5 need select the same clock, although it is arbitrary which clock is selected. It is assumed here that both the first switch 3 and the second switch 5 select the clock outputted from the first voltage controlled oscillator 1, for example. As a result, the digital TV signal processor 11 and the recording processor 12 use the identical reference clock, so that the video and the audio outputted from the digital TV signal processor 11 are free of distortion.

Next, the case where while the digital broadcast is recorded onto the DVD, the content recorded on the DVD is reproduced will now be described below.

In order to record the digital broadcast onto the DVD, data of the digital broadcast need be decoded, and the resulting baseband signal need be converted into the DVD format before being recorded onto the DVD. Meanwhile, the content recorded on the DVD need be read therefrom and then decoded for output.

Upon reception of the digital broadcast, the content of the digital broadcast is inputted to the A/V stream decoder 112, which forms a part of the digital TV signal processor 11. The A/V stream decoder 112 decodes the format thereof specific to the digital broadcast, and outputs the resulting baseband video signal and baseband audio signal to the video display unit 111 and the audio output unit 113, respectively. In addition, the A/V stream decoder 112 compares the PCR extracted from the content with the reference clock to generate the phase difference signal, and outputs the generated phase difference signal to the first low pass filter 2. In order to output the distortion-free video and audio to the recording processor 12, the digital TV signal processor 11 need operate using the reference clock that is synchronized with the PCR of the input content. Accordingly, the first switch 3 selects the clock outputted from the first voltage controlled oscillator 1.

The baseband video signal outputted from the digital TV signal processor 11 is inputted to the A/V stream encoder 121 within lo the recording processor 12. The A/V stream encoder 121 converts the video signal into the DVD format. In addition, the A/V stream encoder 121 detects a phase difference between a vertical synchronization signal of the input video signal and the reference clock, and outputs the phase difference signal indicating the detected phase difference to the second low pass filter 14. The second low pass filter 14 receives and smoothes the phase difference signal, and outputs the smoothed phase difference signal to the second voltage controlled oscillator 7. The second switch 5 selects the clock outputted from the second voltage controlled oscillator 7, and outputs the selected clock to the second PLL 6. The second PLL 6 receives the selected clock and removes therefrom the unstable phase component that arises during the transition of switching by the second switch 5, and supplies the resulting reference clock to the recording processor 12. As a result, the reference clock of the recording processor 12 becomes identical with the reference clock of the digital TV signal processor 11. In this case, the switch 10 selects the clock outputted from the audio PLL 124 within the recording processor 12. Meanwhile, even when the second switch 5 selects the clock outputted from the first voltage controlled oscillator 1, it is possible to allow the recording processor 12 and the digital TV signal processor 11 to use an identical reference clock. In this case, the switch 10 selects the clock outputted from the audio PLL 114 within the digital TV signal processor 11.

The baseband audio signal outputted from the digital TV signal processor 11 is supplied to the A/V stream encoder 121 within the recording processor 12 via the sampling converter 13. The sampling converter 13 converts the sampling frequency of the audio. The A/V stream encoder 121 receives the audio signal and converts the received audio signal into the DVD format. The A/V stream encoder 121 generates a data stream in the DVD format, and outputs the generated data stream to the recording/reproducing processor 126. The recording/reproducing processor 126 receives the data stream and subjects it to proper processing for recording, and records the resulting data stream onto the recording medium.

At the same time, the content recorded on the DVD is read therefrom, and a data stream thereof is outputted to the recording/reproducing processor 126. The data stream read from the DVD is supplied from the recording/reproducing processor 126 to the A/V stream decoder 125. The subsequent flow of the data stream is the same as the flow described above with reference to the case where the video recorded on a DVD is reproduced; therefore, a description thereof is omitted here.

As described above, because the digital TV signal processor 11 and the recording processor 12 use the identical reference clock, the digital broadcast can be recorded as the video and audio signals free of distortion, while the signal read from the DVD can be reproduced without distortion.

Finally, the case where while the digital broadcast is outputted to be viewed and listened to, the analog broadcast is recorded will now be described below.

Upon reception of the digital broadcast, the content thereof is inputted to the A/V stream decoder 112, which forms a part of the digital TV signal processor 11. The A/V stream decoder 112 decodes the format thereof specific to the digital broadcast, and outputs the resulting baseband video signal and baseband audio signal to the video display unit 111 and the audio output unit 113, respectively. In addition, the A/V stream decoder 112 compares the PCR extracted from the content with the reference clock to generate the phase difference signal, and outputs the generated phase difference signal to the first low pass filter 2. In order to output the distortion-free video and audio, the digital TV signal processor 11 need operate using the reference clock that is synchronized with the PCR of the input content. Accordingly, the first switch 3 selects the clock outputted from the first voltage controlled oscillator 1.

On the other hand, in order to record the analog broadcast as a distortion-free signal, the reference clock of the recording processor 12 need be synchronized with the vertical synchronization signal of the input analog broadcast. Accordingly, the second switch 5 selects the clock outputted from the second voltage controlled oscillator 7. Then, based on the phase difference signal outputted from the A/V stream encoder 121, the second low pass filter 14, the second voltage controlled oscillator 7, the second switch 5, and the second PLL 6 cooperate to generate the reference clock that is synchronized with the vertical synchronization signal of the input analog broadcast, and supply the generated reference clock to the recording processor 12. Needless to say, the switch 10 selects the clock outputted from the audio PLL 124 within the recording processor 12.

Note that the term “DVD” used in the foregoing description may be replaced with “hard disk drive (HDD)”, “Secure Digital (SD) card”, or the like. In such a case, needless to say, data is recorded in a format corresponding to the selected recording medium (i.e., the hard disk drive, the Secure Digital (SD) card, or the like).

Signal processing has been described specifically above with reference to the exemplary four cases to facilitate the explanation. A feature of the present invention lies in operating the first switch 3 and the second switch 5 appropriately to output the distortion-free video and audio signals. Thus, regarding other cases than the above-described four cases, operations of the first switch 3 and the second switch 5 will now be described below.

First, the operation of the first switch 3 will now be described below.

In the case where the digital broadcast is outputted to be viewed and listened to, the first switch 3 selects the output from the first voltage controlled oscillator 1. In the case where the signal read from the recording medium is reproduced, two cases are possible: in the case where the recording of the analog broadcast is not performed at the same time, the first switch 3 may select either the output from the first voltage controlled oscillator 1 or the output from the second voltage controlled oscillator 7; and in the case where the recording of the analog broadcast is performed at the same time, the first switch 3 selects the output from the second voltage controlled oscillator 7.

Next, the operation of the second switch 5 will now be described below.

In the case where the signal of the digital broadcast is recorded, the second switch 5 may select either the output from the first voltage controlled oscillator 1 or the output from the second voltage controlled oscillator 7. In the case where the analog broadcast is recorded, the second switch 5 selects the output from the second voltage controlled oscillator 7. In the case where only the reproducing of the data recorded on the recording medium is performed, the second switch 5 may select either the output from the first voltage controlled oscillator 1 or the output from the second voltage controlled oscillator 7.

In the case where more than one processing is performed at the same time, the operations of the first switch 3 and the second switch 5 follow the above. In the case where either of the output from the first voltage controlled oscillator 1 and the output from the second voltage controlled oscillator 7 is selectable, one with a higher priority should be selected, needless to say.

Note that the second switch 5 and the second PLL 6 can be omitted if the A/V stream encoder 121 has a function of generating the phase difference signal that indicates the phase difference between the reference clock and the vertical synchronization signal of the video signal outputted from the digital TV signal processor 11, and outputting the generated phase difference signal to the second low pass filter 14.

Provision of the communication unit 200 used for communication between a central processing unit of the digital TV signal processor 11 and a central processing unit of the recording processor 12 makes it easy for the first switch 3 and the second switch 5 to perform their switching operations in combination. The switching of the first switch 3 and the second switch 5 will be required when application is changed.

### Second Embodiment

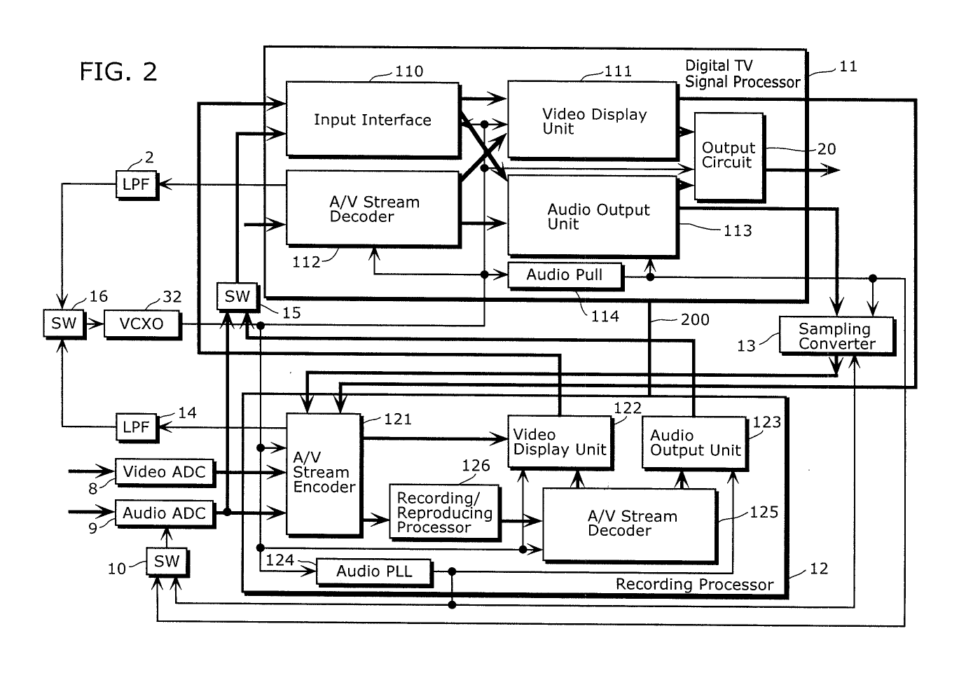

A recording/reproducing apparatus according to the second embodiment of the present invention will now be described below with reference to FIG. 2.

FIG. 2 is a block diagram illustrating a structure of the recording/reproducing apparatus according to the second embodiment of the present invention which receives, records, and reproduces both of digital broadcasts and analog broadcasts.

The recording/reproducing apparatus of FIG. 2 differs from the recording/reproducing apparatus of FIG. 1 in a system for generating the reference clock signals of the digital TV signal processor 11 and the recording processor 12. In more detail, the structure of the recording/reproducing apparatus of FIG. 2 differs from the structure of the recording/reproducing apparatus of FIG. 1 in that the switches 3 and 5 are eliminated but a switch 16 is instead added; the first and second voltage controlled oscillators 1 and 7 are combined to be a single voltage controlled oscillator 32; and the first PLL 4 (PLL_DTV 4 in FIG. 1) and the second PLL 6 (PLL_DVD 6 in FIG. 1) for removing the unstable component that arises during the transition of switching are eliminated. Note that the reference numerals in FIG. 1 are assigned to identical elements in FIG. 2 so that the details of those elements are same as described above. Furthermore, the flows of the video and audio signals in the second embodiment are the same as in the first embodiment; therefore, the descriptions thereof are not explained again below.

The first low pass filter 2 corresponds to the first low pass filter which is claimed in the present invention, and smoothes a phase difference signal between the first reference clock signal and the PCR signal. The second low pass filter 14 corresponds to the second low pass filter which is claimed in the present invention, and smoothes phase difference signal between the second reference clock signal and the vertical synchronization signal.

The switch 16 corresponds to a switch which is claimed in the present invention. The switch 16 selects: the first signal which is smoothed and outputted from the first low pass filter 2; or the second signal which is smoothed and outputted from the second low pass filter 14.

The voltage controlled oscillator 32 corresponds to a voltage controlled oscillator which is claimed in the present invention. The voltage controlled oscillator 32 outputs the first reference clock signal or the second reference clock signal which has a frequency depending on the first signal or the second signal that is selected by the switch 16.

An operation of the switch 16 will now be described below.

In the case where an analog broadcast is recorded onto the recording medium, the switch 16 selects the phase difference signal outputted from the A/V stream encoder 121, i.e., the output from the second low pass filter 14. Thereby, both the digital TV signal processor 11 and the recording processor 12 can be operated using the reference clock that is synchronized with the vertical synchronization signal of the input analog broadcast.

On the other hand, in the case where the signal of the digital broadcast is decoded into the baseband signal and the baseband signal is passed through the A/V stream encoder 121 to be recorded onto the recording medium, the switch 16 selects the phase difference signal outputted from the A/V stream decoder 112, i.e., the output from the first low pass filter 2. Thereby, both the digital TV signal processor 11 and the recording processor 12 can be operated using the reference clock that is synchronized with the PCR of the input digital broadcast.

### Third Embodiment

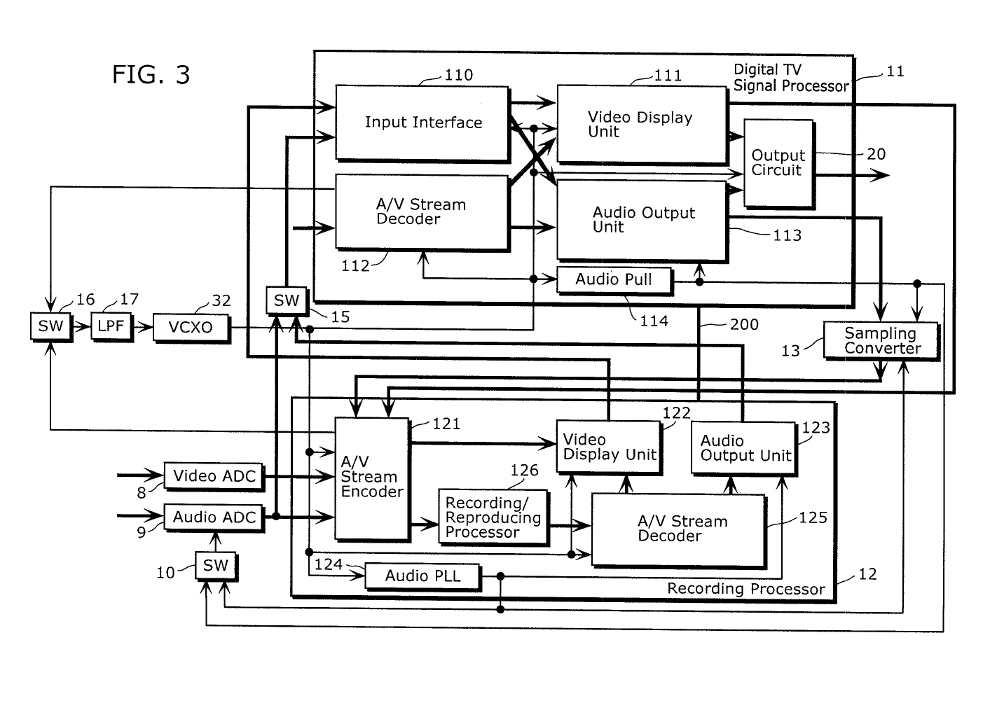

A recording/reproducing apparatus according to the third embodiment of the present invention will now be described below with reference to FIG. 3.

FIG. 3 is a block diagram illustrating a structure of the recording/reproducing apparatus according to the third embodiment of the present invention which receives, records, and reproduces both of digital broadcasts and analog broadcasts. In the recording/reproducing apparatus according to the third embodiment, the number of the low pass filters is reduced.

The recording/reproducing apparatus of FIG. 3 differs from the recording/reproducing apparatus of FIG. 2 mainly in the location of the switch 16. In more detail, the structure of the recording/reproducing apparatus of FIG. 3 differs from the structure of the recording/reproducing apparatus of FIG. 2 in that the first low pass filter 2 and the second low pass filter 14 are eliminated, and that another low pass filter 17 is added between the switch 16 and the voltage controlled oscillator 32.

Note that the reference numerals in FIG. 2 are assigned to identical elements in FIG. 3 so that the details of those elements are same as described above. Furthermore, the flows of the video and audio signals in the third embodiment are the same as in the first and second embodiments; therefore, the descriptions thereof are not explained again below.

The switch 16 corresponds to a switch which is claimed in the present invention, and selects: the phase difference signal between lo the first reference clock signal and the PCR signal, which is extracted from the digital TV signal processor 11; or the phase difference signal between the second reference clock signal and the vertical synchronization signal, which is extracted from the recording processor 12.

The low pass filter 17 corresponds to a low pass filter-which is claimed in the present invention. The low pass filter 17 smoothes the phase difference signal selected by the switch 16, in other words, the phase difference signal between the first reference clock signal and the PCR signal, or the phase difference signal between the second reference clock signal and the vertical synchronization signal.

The voltage controlled oscillator 32 corresponds to a voltage controlled oscillator which is claimed in the present invention. The voltage controlled oscillator 32 outputs the first or second reference clock signal which has a frequency depending on the signal that is smoothed by the low pass filter 17.

As illustrated in FIG. 3, the switch 16 is provided in front of the low pass filter 17, so that the switch 16 can select the phase difference signal prior to the smoothing. Thereby, the recording/reproducing apparatus of the third embodiment has advantages of reducing the number of low pass filters, compared with the recording/reproducing apparatuses of the first and second embodiments. More specifically, the structure of the third embodiment can reduce the number of the low pass filters used in the structure of the first and second embodiments, so that the recording/reproducing apparatus of the third embodiment of FIG. 3 needs only one low pass filter although the recording/reproducing apparatuses of the first and second embodiments of FIGS. 1 and 2 need two low pass filters which are the first low pass filter 2 and the second low pass filter 14.

According to the recording/reproducing apparatus of the third lo embodiment, the number of the low pass filter can be reduced, thereby further increasing cost performance.

Note, however, that it is difficult to optimize the low pass filter 17 depending on the digital broadcast or the analog broadcast. Therefore, the third embodiment is superior in cost performance but slightly inferior in functional performance to the second embodiment.

### Fourth Embodiment

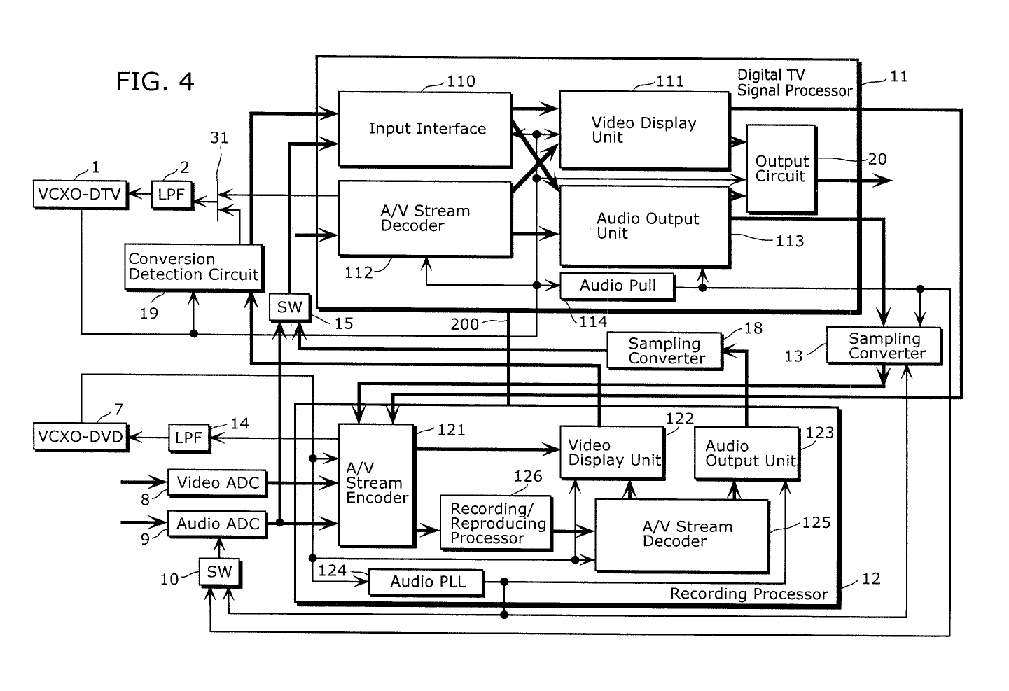

A recording/reproducing apparatus according to the fourth embodiment of the present invention will now be described below with reference to FIG. 4.

FIG. 4 is a block diagram illustrating a structure of the recording/reproducing apparatus according to the fourth embodiment of the present invention which receives, records, and reproduces both of digital broadcasts and analog broadcasts.

The recording/reproducing apparatus of FIG. 4 differs from the recording/reproducing apparatus of FIG. 1 in the system for generating the reference clocks of the digital TV signal processor 11 and the recording processor 12, and in systems for inputting audio and video signals of the analog broadcast from the recording processor 12 to the digital TV signal processor 11 (hereinafter, these systems are referred to as an “audio signal path” and a “video signal path”, respectively).

In more detail, the recording/reproducing apparatus of FIG. 4 differs from the recording/reproducing apparatus of FIG. 1 in that the first switch 3, the first PLL 4, the second switch 5, and the second PLL 6 are eliminated, and that another sampling converter 18, a conversion detection circuit 19, and a switch 31 are added. The above difference is also seen, comparing to the recording/reproducing apparatuses of FIGS, 2 and 3. Note that the reference numerals in FIG. 1 are assigned to identical elements in FIG. 4 so that the details of those elements are same as described above. The following will describe the difference in more detail.

The sampling converter 18 converts a sampling frequency of the audio signals received from the A/V stream decoder 125 of the recording processor 12, and then provides the converted frequency to the switch 15 of the digital TV signal processor 11.

The conversion detection circuit 19 corresponds to a circuit which is claimed in the present invention. The conversion detection circuit 19 includes a rate conversion circuit and a phase difference signal detection circuit. The rate conversion circuit convert a digital baseband signal, which is a video signal digitalized and outputted by the recording processor 12, into a standard signal in synchronization with the first reference clock signal. The phase difference signal detection circuit detects a phase difference signal by comparing the digital baseband signal to the first reference clock signal, and then outputs the detected phase difference signal.

The switch 31 corresponds to a switch which is claimed in the present invention. The switch 31 selects: the phase difference signal between the first reference clock signal and the PCR signal, which is extracted by the digital TV signal processor 11; or the phase difference signal outputted from the conversion detection circuit 19.

The first low pass filter 2 corresponds to the first low pass filter which is claimed in the present invention, and smoothes the phase difference signal selected by the switch 31, in other words, the phase difference signal between the first reference clock signal and the PCR signal or the phase difference signal from the conversion detection circuit 19.

The second low pass filter 14 corresponds to the second low pass filter which is claimed in the present invention, and smoothes phase difference signal between the second reference clock signal and the vertical synchronization signal.

The first voltage controlled oscillator 1 corresponds to the first voltage controlled oscillator which is claimed in the present invention, and outputs the first reference clock signal having a frequency depending on a signal smoothed by the first low pass filter 2.

The second voltage controlled oscillator 7 corresponds to a second voltage controlled oscillator which is claimed in the present invention. The second voltage controlled oscillator 7 outputs the second reference clock signal having a frequency depending on a signal smoothed by the second low pass filter 14.

First, the audio signal path will now be described below.

The sampling converter 18 is inserted on the audio signal path from the recording processor 12 to the digital TV signal processor 11. This insertion of the sampling converter 18 enables the reference clock of the recording processor 12 to be used as the reference clock of the digital TV signal processor 11.

Next, the video signal path will now be described below.

The conversion detection circuit 19 is inserted on the video signal path from the recording processor 12 to the digital TV signal processor 11. The conversion detection circuit 19 combines with the first low pass filter 2 and the first voltage controlled oscillator 1 to form a phase locked loop A. At this time, the switch 31 selects an output from the conversion detection circuit 19. The phase locked loop A generates a clock that is synchronized with the vertical synchronization signal of the video signal outputted from the recording processor 12 to the digital TV signal processor 11. This clock is used as the reference clock of the digital TV signal processor 1.

An operation of the switch 31, which is a major feature of the present embodiment, will now be described below.

In the case where a digital broadcast is outputted to be viewed and listened to, the switch 31 selects the phase difference signal outputted from the A/V stream decoder 112. In the case where the signal of an analog broadcast outputted from the lo recording processor 12 is outputted to be viewed and listened to, the switch 31 selects the phase difference signal outputted from the conversion detection circuit 19. Thereby, it is possible to reproduce the video and audio of the content to be viewed and listened to without distortion.

For example, in the case where the analog broadcast is outputted to be viewed and listened to, the switch 31 selects the phase difference signal outputted from the conversion detection circuit 19. Meanwhile, in the case where while the digital broadcast is recorded onto the DVD, the content recorded on the DVD is reproduced to be viewed and listened to, the content inputted to the recording processor 12 is the digital broadcast; therefore, when the digital broadcast is outputted to be viewed and listened to, the switch 31 selects the phase difference signal outputted from the A/V stream decoder 112. Note, however, that because the second low pass filter 14, the second voltage controlled oscillator 7, and the A/V stream encoder 121 cooperate to generate the reference clock that is synchronized with the vertical synchronization signal of the input video signal, the reference clock of the recording processor 12 is synchronized with the reference clock of the digital TV signal processor 11.

### Fifth Embodiment

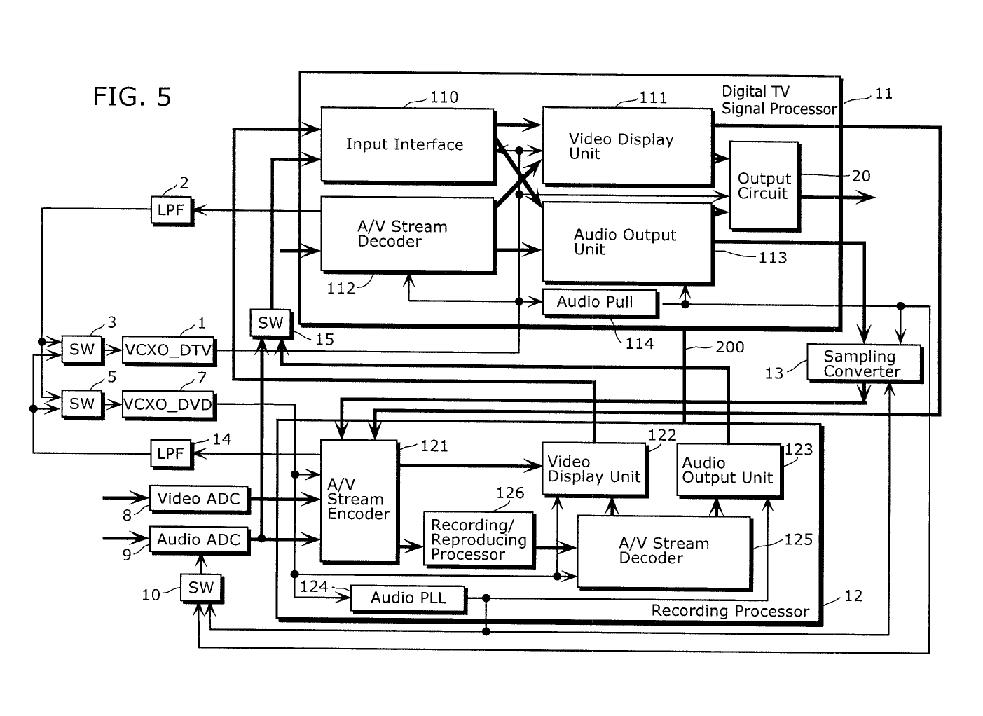

A recording/reproducing apparatus according to the fifth embodiment of the present invention will now be described below with reference to FIG. 5.

FIG. 5 is a block diagram illustrating a structure of the recording/reproducing apparatus according to the fifth embodiment of the present invention which receives, records, and reproduces both of digital broadcast and analog broadcast.

The recording/reproducing apparatus of FIG. 5 differs from the recording/reproducing apparatus of FIG. 1 in the system for generating the reference clocks of the digital TV signal processor 11 and the recording processor 12. More specifically, the insertion locations of the first and second switches 3 and 5 are different. In more detail, the structure of the recording/reproducing apparatus of FIG. 5 differs from the structure of the recording/reproducing apparatus of FIG. 1 in that the first and second switches 3 and 5 are located prior to the first and second voltage controlled oscillators 1 and 7, respectively, and that the first and second PLLs 4 and 6 are eliminated. Note that the reference numerals in FIG. 1 are assigned to identical elements in FIG. 5 so that the details of those elements are same as described above.

By the above structure, although the flows of the reference clocks and the video and audio signals are the same as in the first embodiment, the recording/reproducing apparatus according to fifth embodiment is advantageous in elimination of the first PLL 4 and the second PLL 6. Note, however, that when the first switch 3 selects the output from the second low pass filter 14, the second switch 5 cannot select the output from the first low pass filter 2. This is because a feedback loop is not formed in that case.

### Sixth Embodiment

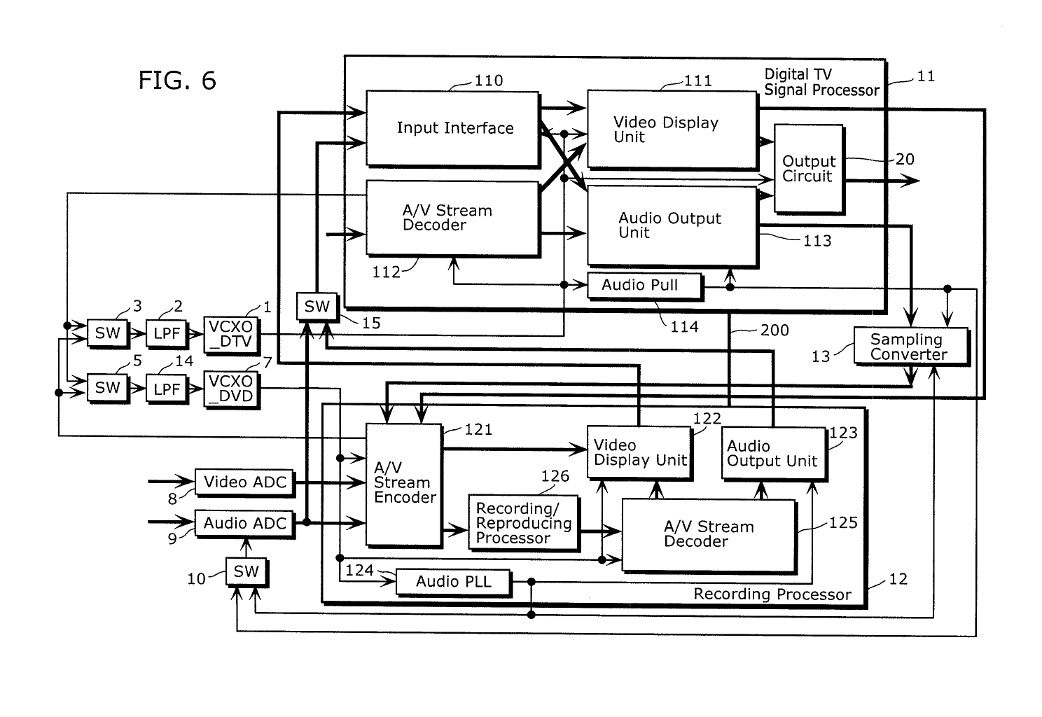

A recording/reproducing apparatus according to the sixth embodiment of the present invention will now be described below with reference to FIG. 6.

FIG. 6 is a block diagram illustrating a structure of the recording/reproducing apparatus according to the sixth embodiment of the present invention which receives, records, and reproduces both of digital broadcasts and analog broadcasts. In the recording/reproducing apparatus according to the sixth embodiment, the first and second PLLs 4 and 6 are eliminated.

The recording/reproducing apparatus of FIG. 6 differs from the recording/reproducing apparatus of FIG. 1 in the system for generating the reference clocks of the digital TV signal processor 11 and the recording processor 12. More specifically, the insertion locations of the first and second switches 3 and 5 are different. In more detail, the structure of the recording/reproducing apparatus of FIG. 6 differs from the structure of the recording/reproducing apparatus of FIG. 1 in that the first switch 3 is located prior to the first low pass filter 2, and that the second switch 5 is located prior to the second low pass filter 14, and that the first and second PLLs 4 and 6 are eliminated. Note that the reference numerals in FIG. 1 are assigned to identical elements in FIG. 6 so that the details of those elements are same as described above.

Here, each of the first and second switches 3 and 5 corresponds to a selection unit which is claimed in the present invention, and selects the phase difference signal between the first reference clock signal and the PCR signal or the phase difference signal between the second reference clock signal and the vertical synchronization signal.

Each of the first and second low pass filters 2 and 14 corresponds to a low pass filter which is claimed in the present invention, and smoothes the phase difference signal selected by the first switch 3 or the second switch 5, in other words, the phase difference signal between the first reference clock signal and the PCR signal and the phase difference signal between the second reference clock signal and the vertical synchronization signals.

The first voltage controlled oscillator 1 corresponds to the first voltage controlled oscillator which is claimed in the present invention, and outputs the first or second reference clock signal having a frequency depending on a signal smoothed by the first low pass filter 2.

The second voltage controlled oscillator 7 corresponds to the first voltage controlled oscillator which is claimed in the present invention, and outputs the first or second reference clock signal having a frequency depending on a signal smoothed by the second low pass filter 14.

By the above structure, while the flows of the reference clocks and the video and audio signals are the same as in the first embodiment, the recording/reproducing apparatus of the sixth embodiment is advantageous in the elimination of the first PLL 4 and the second PLL 6.

Moreover, the recording/reproducing apparatus of the sixth embodiment differs from the recording/reproducing apparatus of the fifth embodiment in that the first and second switches 3 and 5 serve as stages prior to the first and second low pass filters 2 and 14 used for smoothing, respectively. Thus, the recording/reproducing apparatus of the sixth embodiment is advantageous in that the first and second low pass filters 2 and 14 serve to remove fluctuations that arise during the transition of switching by the first and second switches 3 and 5.

As described above, the recording/reproducing apparatuses according to the above-described embodiments of the present invention, which include the digital TV signal processor 11 and the recording processor 12, implement output processing on the digital TV signal processor 11 side, with no need to have two final output units. Moreover, the recording/reproducing apparatuses include, in the system for generating the reference clocks of the digital TV signal processor 11 and the recording processor 12, the switch(es) for selectively transferring the optimum reference clocks to the digital TV signal processor 11 and the recording processor 12 and optionally the PLL(s) for removing the unstable component that arises during the transition of switching by the switch(es). Thus, the switch(es) is controlled properly to suit the application, such as recording, reproducing, broadcast viewing, or the like. Thus, in various applications (e.g., the recording or reproducing of the digital broadcast, the recording or reproducing of the analog broadcast, the broadcast viewing, etc.), the recording/reproducing apparatuses can achieve the viewing and listening of the distortion-free video and audio without the need to use a conventional video signal switching device, which is expensive.

Note also that a part of all of the functional blocks in the block diagrams may be implemented into a system large integrated circuit (LSI). The system LSI is a super-multi-function LSI, such as a computer system including a microprocessor, a ROM, a RAM, and the like. The RAM stores a computer program. The microprocessor operates according to the computer program, thereby realizing the functions of the system LSI.

Note also that functional blocks in the block diagrams may be integrated separately, or a part or all of them may be integrated into a single chip.

Here, the integrated circuit is referred to as a LSI, but the integrated circuit can be called an IC, a system LSI, a super LSI or an ultra LSI depending on their degrees of integration. Note also that the technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

Although only some exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The recording/reproducing apparatus which records digital broadcasts and analog broadcasts according to the present invention provides an inexpensive recording/reproducing apparatus that includes a system for generating an optimum reference clock at the time of recording, reproducing, and viewing, and thus enables a user to view and listen to distortion-free video and audio in various applications. This recording/reproducing apparatus is usable as an apparatus or a system for recording the digital broadcasts and the analog broadcasts, for example.

What is claimed is:

1. A recording and reproducing apparatus which receives, records, and reproduces a digital broadcast and an analog broadcast, said apparatus comprising:
a digital television signal processor operable to (i) receive the digital broadcast, (ii) extract a program clock reference signal from a stream of the received digital broadcast, (iii) output a digital signal of the digital broadcast, according to a first reference clock signal which is generated based on the program clock reference signal, and (iv) output a digital signal of the analog broadcast of a recording processor;
said recording processor operable to (i) receive the analog broadcast, (ii) extract a vertical synchronization signal from the received analog broadcast, (iii) digitalize the received analog broadcast, and (iii-1) record the digital signal of the analog broadcast into which the analog broadcast is digitalized onto a recording medium or (iii-2) output the digital signal of the analog broadcast to said digital television signal processor, according to a second reference clock signal which is generated based on the vertical synchronization signal, and (iv) simultaneously or independently record, onto the recording medium, the digital signal of the digital broadcast which is received from said digital television signal processor; and
a provision unit operable to (i) provide, as a clock signal, one of (a″) the first reference clock signal and (b″) the second reference clock signal to said digital television signal processor, and (ii) provide, as a clock signal, one of (a″) the first reference clock signal and (b″) the second reference clock signal to said recording processor,
wherein said digital television signal processor is operable to output the digital signal of the analog broadcast according to the second reference clock signal instead of the first reference clock signal, when the second reference clock signal is provided as the clock signal from said provision unit, and
said recording processor is operable to record the digital signal of the digital broadcast onto the recording medium, according to the first reference clock signal instead of the second reference clock signal, when the first reference clock signal is provided as the clock signal from said provision unit.

2. The recording and reproducing apparatus according to claim 1,
wherein said provision unit is operable to provide the first reference clock signal as the clock signal to said recording processor, when said recording processor records the digital signal of the digital broadcast onto the recording medium.

3. The recording and reproducing apparatus according to claim 1,
wherein said provision unit is operable to provide the second reference clock signal as the clock signal to said digital television signal processor, when said digital television signal processor outputs the digital signal of the analog broadcast, in order to be viewed or listened to, the digital signal being received from said recording processor.

4. The recording and reproducing apparatus according to claim 1,
wherein said provision unit includes:
a first clock signal generation unit operable to generate the first reference clock signal based on the program clock reference signal;
a second clock signal generation unit operable to generate the second reference clock signal based on the vertical synchronization signal; and
a selection unit operable to (i) select one of the first reference clock signal and the second reference clock signal, and (ii) provide the selected reference clock signal as the clock signal.

5. The recording and reproducing apparatus according to claim 4,
wherein said first clock signal generation unit includes:
a first low pass filter operable to smooth (a) a phase difference signal between the first reference clock signal and the program clock reference signal; and
a first voltage controlled oscillator operable to output (a″) the first reference clock signal which has a frequency depending on the phase difference signal smoothed by said first low pass filter, and said second clock signal generation unit includes:
a second low pass filter operable to smooth (b) a phase difference signal between the second reference clock signal and the vertical synchronization signal; and
a second voltage controlled oscillator operable to output (b″) the second reference clock signal which has a frequency depending on the phase difference signal smoothed by said second low pass filter.

6. The recording and reproducing apparatus according to claim 4,
wherein said provision unit further includes
a phase synchronization circuit operable to remove an unstable phase component from the first reference clock signal or the second reference clock signal which is outputted by said selection unit.

7. The recording and reproducing apparatus according to claim 5,
wherein said provision unit further includes
a phase synchronization circuit operable to remove an unstable phase component from the first reference clock signal or the second reference clock signal which is outputted by said selection unit.

8. The recording and reproducing apparatus according to claim 1, further comprising:
an audio signal conversion unit operable to convert an analog audio signal of the analog broadcast into a digital audio signal;
a clock output unit operable to output the clock signal provided by said provision unit to said audio signal conversion unit; and
an audio output unit operable to (i) select one of (m) the digital audio signal which is obtained from said audio signal conversion unit and (n) a digital audio signal of the digital signal of the analog broadcast and the digital broadcast, which is obtained from said recording processor, and (ii) outputs the selected digital audio signal to said digital television signal processor.

9. The recording and reproducing apparatus according to claim 2, further comprising:
an audio signal conversion unit operable to convert an analog audio signal of the analog broadcast into a digital audio signal;
a clock output unit operable to output the clock signal provided by said provision unit to said audio signal conversion unit; and
an audio output unit operable to (i) select one of (m) the digital audio signal which is obtained from said audio signal conversion unit and (n) a digital audio signal of the digital signal of the analog broadcast and the digital broadcast, which is obtained from said recording processor, and (ii) outputs the selected digital audio signal to said digital television signal processor.

10. The recording and reproducing apparatus according to claim 1,
wherein said provision unit includes
a clock signal generation unit operable to generate the first reference clock signal based on the program clock reference signal or the second reference clock signal based on the vertical synchronization signal,
wherein said clock signal generation unit includes:
a first low pass filter operable to smooth (a) a phase difference signal between the first reference clock signal and the program clock reference signal;
a second low pass filter operable to smooth (b) a phase difference signal between the second reference clock signal and the vertical synchronization signal;
a switch operable to select one of (a′) a first signal which is smoothed and outputted by said first low pass filter and (b′) a second signal which is smoothed and outputted by the second low pass filter; and
a voltage controlled oscillator operable to output (a″) the first reference clock signal which has a frequency depending on the first signal or (b″) the second reference clock signal which has a frequency depending on the second signal, the first and second signal being selected by said switch.

11. The recording and reproducing apparatus according to claim 1,
wherein said provision unit includes
a clock signal generation unit operable to generate (a″) the first reference clock signal based on the program clock reference signal or (b″) the second reference clock signal based on the vertical synchronization signal,
wherein said clock signal generation unit includes:
a switch operable to select one of (a) a phase difference signal between the first reference clock signal and the program clock reference signal which is extracted by said digital television signal processor and (b) a phase difference signal between the second reference clock signal and the vertical synchronization signal which is extracted by said recording processor;
a low pass filter operable to smooth (a) the phase difference signal between the first reference clock signal and the program clock reference signal or (b) the phase difference signal between the second reference clock signal and the vertical synchronization signal, the phase difference signal to be smoothed being selected by said switch; and
a voltage controlled oscillator operable to output (a″) the first reference clock signal which has a frequency depending on the phase difference signal between the first reference clock signal and the program clock reference signal or (b″) the second reference clock signal which has a frequency depending on the phase difference signal between the second reference clock signal and the vertical synchronization signal, the phase difference signal being smoothed by said low pass filter.

12. The recording and reproducing apparatus according to claim 1,
wherein said provision unit includes
a clock signal generation unit operable to generate (a″) the first reference clock signal based on the program clock reference signal or (b″) the second reference clock signal based on the vertical synchronization signal,
wherein said clock signal generation unit includes:
a first low pass filter operable to smooth (a) a phase difference signal between the first reference clock signal and the program clock reference signal;
a second low pass filter operable to smooth (b) a phase difference signal between the second reference clock signal and the vertical synchronization signal;
a first switch and a second switch, each of which is operable to select one of (a′) a first signal which is smoothed by said first low pass filter and (b′) a second signal which is smoothed by said second low pass filter;
a first voltage controlled oscillator operable to output (a″) the first reference clock signal which has a frequency depending on the first signal or (b″) the second reference clock signal which has a frequency depending on the second signal, the first and second signal being selected by said first switch;
a second voltage controlled oscillator operable to output (a″) the first reference clock signal which has a frequency depending on the first signal or (b″) the second reference clock signal which has a frequency depending on the second signal, the first and second signal being selected by said second switch; and
wherein said provision unit is operable to provide, as the clock signal, the first or second reference clock signal outputted from said first voltage controlled oscillator, to said digital television signal processor, and provide, as the clock signal, the first or second reference clock signal outputted from said second voltage controlled oscillator, to said recording processor.

13. The recording and reproducing apparatus according to claim 1,
wherein said provision unit includes:
a selection unit operable to select one of (a) a phase difference signal between the first reference clock signal and the program clock reference signal and (b) a phase difference signal between the second reference clock signal and the vertical synchronization signal; and
a clock signal generation unit operable to generate (a″) the first reference clock signal based on the phase difference signal between the first reference clock signal and the program clock reference signal, or (b″) the second reference clock signal based on the phase difference signal between the second reference clock signal and the vertical synchronization signal, the phase difference signal being selected by said selection unit,
wherein said clock signal generation unit includes: a low pass filter operable to smooth (a) the phase difference signal between the first reference clock signal and the program clock reference signal or (b) the phase difference signal between the second reference clock signal and the vertical synchronization signal, the phase difference signal to be smoothed being selected by said selection unit;
a first voltage controlled oscillator and a second voltage controlled oscillator, each of which is operable to output (a″) the first reference clock signal which has a frequency depending on the phase difference signal between the first reference clock signal and the program clock reference signal, or (b″) the second reference clock signal which has a frequency depending on the phase difference signal between the second reference clock signal and the vertical synchronization signal, the phase difference signal being smoothed by said low pass filter,
wherein said provision unit is operable to provide, as the clock signal, the first or second reference clock signal outputted from said first voltage controlled oscillator, to said digital television signal processor, and provide, as the clock signal, the first or second reference clock signal outputted from said second voltage controlled oscillator, to said recording processor.

14. A recording and reproducing apparatus which receives, records, and reproduces a digital broadcast and an analog broadcast, said apparatus comprising:
a digital television signal processor operable to (i) receive the digital broadcast, (ii) extract a program clock reference signal from a stream of the received digital broadcast, (iii) output a digital signal of the digital broadcast, according to a first reference clock signal which is generated based on the program clock reference signal, and (iv) output a digital signal of the analog broadcast which is outputted from a recording processor;
said recording processor operable to (i) receive the analog broadcast, (ii) extract a vertical synchronization signal from the received analog broadcast, (iii) digitalize the received analog broadcast, and (iii-1) record the digital signal of the analog broadcast into which the analog broadcast is digitalized onto a recording medium or (iii-2) output the digital signal of the analog broadcast to said digital television signal processor, according to a second reference clock signal which is generated based on the vertical synchronization signal, and (iv) simultaneously or independently record, onto the recording medium, the signals of the digital broadcast which is received from said digital television signal processor;
a circuit includes (x) a rate conversion circuit operable to convert a digital baseband signal into a standard signal in synchronization with the first reference clock signal, the digital baseband signal being a video signal of the digital signal of the analog broadcast which is digitalized and outputted from said recording processor, and (y) a phase difference signal detection circuit operable to detect a phase difference signal by comparing the digital baseband signal with the first reference clock signal and output the detected phase difference signal;
a switch operable to select one of (a) a phase difference signal between the first reference clock signal and the program clock reference signal which is extracted by said digital television signal processor, and (c) the phase difference signal which is outputted from said circuit;
a first low pass filter operable to smooth (a) the phase difference signal between the first reference clock signal and the program clock reference signal, or (c) the phase difference signal which is outputted from said circuit, the phase difference signal to be smoothed being selected by said switch;
a first voltage controlled oscillator operable to output (a″) the first reference clock signal which has a frequency depending on the phase difference signal smoothed by said first low pass filter;
a second low pass filter operable to smooth (b) a phase difference signal between the first reference clock signal and the vertical synchronization signal which is extracted by said recording processor; and
a second voltage controlled oscillator operable to output (b″) the second reference clock signal which has a frequency depending on the phase difference signal smoothed by said second low pass filter.
